(19) United States
(12) Patent Application Publication
(10) Pub. No.: US 2002/0006526 A1
(43) Pub. Date: Jan. 17, 2002

(54) Aluminum silicon carbide and copper clad material and manufacturing process

(76) Inventors: Frank J. Polese, San Diego, CA (US); Walter V. Chichra, Armonk, NY (US); Anthony P. Grodio, Armonk, NY (US); Kenneth J. Huth, Armonk, NY (US)

Correspondence Address: CHARMASSON & BUCHACA, 1545 HOTEL CIRCLE SOUTH, SUITE 150, SAN DIEGO, CA, 92108-3412, US

(21) Appl. No.: 09/802,487

(22) Filed: Mar. 9, 2001

Related U.S. Application Data
(63) Continuation-in-part of application No. 09/415,698, filed on Oct. 11, 1999, now Pat. No. 6,250,127.
(60) Provisional application No. 60/188,523, filed on Mar. 10, 2000.

(51) Int. Cl. B32B 15/20; B32B 5/00

(52) U.S. Cl. 428/654; 228/235.2; 228/235.3; 428/652; 428/627; 428/650; 428/940

(57) ABSTRACT

A ceramic metal matrix composite and copper material having a layer of ceramic metal matrix composite such as aluminum silicon carbide (Al—SiC) bonded to a layer of metal such as copper useful for forming heat-dissipating components for microelectronics concerned with lightweight, high stiffness, high thermal conductivity and compatible thermo expansion characteristics. The clad material may be formed from plurality of sucessive layers of composite and metal. The material is formed by rolling an extruded strip of Al—SiC with the metal layer. Alternately, an interim layer of aluminum, aluminum silicon or other bond-enhancing material is clad to the metal layer prior to rolling it with the composite. The interim layer is thought to form a stronger bond with the exposed aluminum matrix portion of the composites layer.

### PRIOR APPLICATION

This application is a continuation-in-part of co-pending U.S. application Ser. No. 09/415,698 filed Oct. 11, 1999.

### FIELD OF THE INVENTION

This invention relates to materials science and powder metallurgy, and more particularly to the manufacturing of heat-dissipating sheet material for use in electronic systems substrates and packaging, and other applications using lightweight heat-dissipating structures.

### BACKGROUND OF THE INVENTION

Although the present invention is applicable to many areas of technology requiring heat dissipating structures having low density, high specific stiffness and adjustable thermal expansion characteristics, its details will be described in terms of its application to electronics, and particularly with respect to the fabrication of heat-dissipating printed circuit board stiffners, cores or pallets.

Nowadays, most electronic equipment requires the use of structures which are capable of dissipating the heat generated by the active parts of the circuitry. The constant drive toward further miniaturization has resulted in a corresponding increase in the heat generated by individual components such as integrated circuit chips and in a densification of such components on a given circuit board.

The thermal conductivity (“K” or “TC”) of a material is defined as the time rate of heat transfer through unit thickness, across unit area, for a unit difference in temperature or K=WL/AT where W=watts, L=thickness in meters, A=area in square meters, and T=temperature difference in ° K or ° C.

Printed circuit boards are typically made from organic materials such as cured epoxy or polyamide (nylon) having relatively low theremal conductivity and are therefore ineffective at adequately dissipating heat.

This led to the development of heat dissipating substrates, cores or pallets which directly contact the boards. Referring now to FIG. 1, there is shown a fully populated printed circuit board 1 mounted upon a lower heat-dissipating pallet 2. The pallet is made from high thermal conductivity materials such as copper. The electrically conductive copper allows the pallet to act as a common ground plane for the entire board allowing a greater density of heat to be carried through the component leads or board traces.

Unfortunately, materials such as copper have far different thermal expansion characteristics than printed circuit board materials. The coefficient of thermal expansion (“CTE”) or simply the thermal expansion of a material is defined as the ratio of the change in length per degree Celsius to the length at 25° C. It is usually given as an average value over a range of temperatures.

The structures in direct contact with one another preferably have compatible thermal expansion characteristics. Otherwise, stresses caused by the disproportionate expansion may cause separations along the boundary between structures reducing thermal dissipation efficiency and even damaging components

As shown in FIGS. 1 and 2 of the prior art, in order to overcome the disproportionate expansion, the board can be bonded to the pallet with a somewhat pliable layer of thermal epoxy. However, most commercially available thermal epoxies have relatively poor thermal conductivity, typically ranging between 0.2 and 20 W/m° K. Therefore, for greater heat flow, the thickness of the epoxy layer is minimized. But, a thinner epoxy layer is less capable of accommodating any expansion mismatch between the board and pallet. Alternately, the board 1 may be fastened to the pallet 2 using nuts and bolts 3. This allows the use of a non-adhesive layer 4 such as thermal grease at the board to pallet interface. Again, however, most commonly available thermal greases still have inadequate thermal conductivities.

Since thermal efficiency is furthered by close contact between adjacent structures, those structures should have a uniformly smooth and flat interface. Because pallets and circuit boards are typically thin sheets having a large area of contact, it is important the pallet material be stiff. Also, in many applications such as aerospace electronics, overall reduction in weight is desirable. Therefore, high specific stiffness, which in this specification is a measure of stiffness per unit density, is desirable.

Unfortunately, copper sheets are not adequately stiff unless thickness is increased to a point where overall weight is unacceptable.

It is well-known to form pallets or substrates from a laminate of copper and invar brand alloy sheets as disclosed in Baldwin, et al., U.S. Pat. No. 4,509,096. Invar is an alloy of about 36 weight percent of nickel and the balance iron, having a thermal conductivity of about 10.5 W/m-K and a density of about 8.05 g/cm³. Although invar has a density similar to copper, it is far stiffer and enjoys a much lower CTE. Therefore, the thicknesses of the layers in copper-invar laminate can be adjusted so that its overall CTE closely matches the circuit board material while maintaining a high degree of stiffness. However, it is desirable to further reduce the overall weight of the part while maintaining or enhancing stiffness and thermal conductivity.

As noted in Yamada et al., U.S. Pat. No. 4,994,417 incorporated herein by this reference, it has been found useful to form heat-dissipating structures from adjustable CTE, relatively high thermal conductivity, lightweight metal matrix composites such as aluminum-silicon-carbide (“Al—SiC”). Al—SiC is a metal matrix composite wherein silicon carbide (“SiC”) particles are dispersed in an aluminum (“Al”) or aluminum alloy matrix. The proportions of the Al to the SiC are selected to provide a compatible overall CTE while maintaining high thermal conductivity along with acceptable other characteristics such as homogeneity, smoothness and flatness, with good oxidative and hermetic stability.

Al—SiC composites having volume fractions of at least 20% SiC enjoy overall CTEs of less than 17×10⁻⁶/° C. which compares favorably with the CTE of the circuit board or an intermediate buffer layer, while maintaining thermal conductivities in the range of about 130 W/m° K to 210 W/m° K and lightweight densities of between about 2.8 g/cm³ and about 3.0 g/cm³.

Bulk Al—SiC may be manufactured in any of a number of well-known methods as disclosed in Yamada, supra, Yamagata, et al., Development of Low Cost Sintered Al—SiC Composite, 1998 International Symposium on Microelectronics, Nov. 1-4, 1998; Kurada et al., U.S. Pat. No. 4,680,618 and Hammond et al., U.S. Pat. No. 5,186,234, all of which are incorporated herein by this reference.

However, Al—SiC by itself is not a preferred material with which to make thin, sheet-like structures having surface areas of up to 2500 square cm and be between 1.1 and 4.0 mm thick. First, thin Al—SiC sheets are very brittle and would likely crack if subjected to the environments common to pallets, or substrates. Second, it is difficult to form the thin, flat, and smooth structures required, without a large amount of machining after the composite has been formed. Due to the hardness and abrasiveness of SiC, Al—SiC composites containing even low volume fractions of SiC are difficult to machine. Even expensive diamond and carbide cutting tools exhibit rapid wear. Also, the brittle composites themselves are subjected to stresses during machining which may cause chipping or cracking, or other deformations.

Therefore, the instant invention results from a need in the electronics field for high volume, low cost manufacturing of lightweight, heat-dissipating, stiff sheet structures.

### SUMMARY OF THE INVENTION

The principal and secondary objects of this invention are to provide an inexpensively manufactured, stiff, lightweight, heat-dissipating sheet structure such as an integrated circuit chip carrier substrate or printed circuit board core or pallet having a CTE compatible with common circuit board material, and adequately uniform smoothness and flatness.

These and other objects are achieved by selecting a mass produced quantity of metal-matrix composite material such as Al—SiC, forming that material into a thin ribbon, then cladding that material to a ribbon of metal such as copper. The clad material may contain a plurality of successive layers of composite and metal.

The Al—SiC ribbon may be formed by successively hot-rolling an extruded strip of Al—SiC. In this way, commonly available Al—SiC composites manufactured in high volume for use in other applications such as cast automotive parts may be used.

The clad material is formed by rolling the composite ribbon with the metal ribbon. Preferably, an interim, bond-enhancing layer of aluminum, aluminum silicon or other material is pre-clad to the metal layer prior to rolling it with the composite ribbon. In the case of cladding Al—SiC and copper ribbons, an interim layer of aluminum is thought to form a stronger bond with the exposed aluminum matrix portion of the Al—SiC ribbon

### BRIEF DESCRIPTION OF THE DRAWING

FIG. 1 is a prior art diagrammatic perspective view of a fully populated printed circuit board having a lower heat-dissipating pallet;

FIG. 2 is a prior art diagrammatic cross-sectional view of a printed circuit board, mounted upon a heat-dissipating pallet;

FIG. 3 is a partial diagrammatic perspective view of a ribbon of AlSiC composite material according to the invention;

FIG. 4 is a diagrammatic cross-sectional view thereof taken along line 4-4;

FIG. 5 is a diagrammatic side view of the pre-cladding operation of the oter metal material strip with the bonding-enhancing material strip;

FIG. 6 is a diagrammatic side view of the cladding operation of the preclad metal ribbon with the AlSiC composite material strip;

FIG. 7 is a partial diagrammatic perspective view of a sheet of AlSiC-metal clad material according to the invention;

FIG. 8 is a diagrammatic cross-sectional view thereof taken along line 8-8;

FIG. 9 is a diagrammatic side view of the cladding operation of the preclad metal ribbon with the AlSiC—Al—Cu clad ribbon;

FIG. 10 is a diagrammatic side view of the cladding operation of two preclad metal ribbons with the AlSiC composite material ribbon;

FIG. 11 is a diagrammatic cross-sectional view of the Cu—Al—AlSiC—Al—Cu ribbon;

FIG. 12 is a flow-chart diagram of the process steps for forming the Cu—Al—AlSiC ribbon of the invention; and

FIG. 13 is a flow-chart diagram of the process steps for forming the preclad ribbon of the invention.

### DESCRIPTION OF THE PREFERRED EMBODIMENT OF THE INVENTION

The preferred embodiment of the invention will be described in relation to the manufacture of sheet material useful for forming printed circuit board stiffeners, cores or pallets. It is clear to those skilled in the art that the invention is applicable to the manufacture of other structures such as heat-sinks, heat-dissipating buffer layers, and integrated circuit substrates or other packaging.

Although the preferred embodiment describes the formation of a Cu—Al—AlSiC or Cu—Al—AlSiC—Al—Cu clad laminate, it shall be clear to those skilled in the art that other AlSiC-based clad laminates may be formed using the invention such as X—Al—AlSiC, X—Al—AlSiC—Al—X, where X is other metals precladable to aluminum such as steel, nickel-iron alloys, Kovar, Titanium and bronze. Further, replacement of aluminum with aluminum-silicon may be made for other applications.

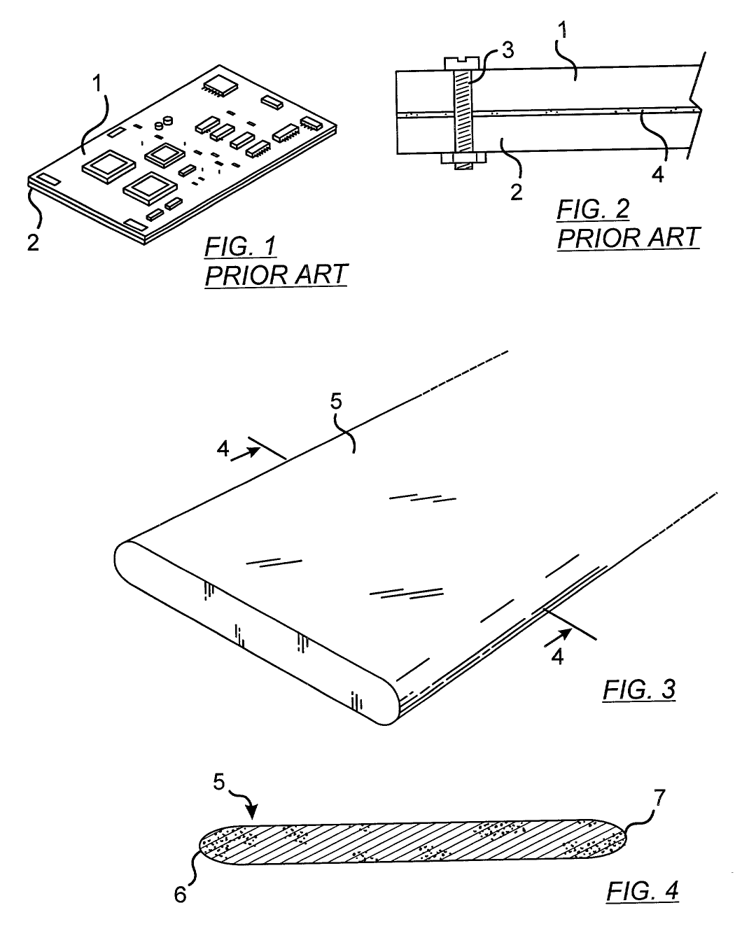

Referring now to the drawing, FIGS. 3 and 4, in a first embodiment, a thin ribbon 5 of Al—SiC material is selected which is between about 0.025 and 0.25 inch, and most preferrably about 0.170 inch thick, and between about 0.25 and 10.0 inches wide, and at least a fewe feet in length. Most preferably, the ribbon is dozens of feet in length and wound upon a spool.

The Al—SiC material has many particles of silicon carbide (“SiC”) reinforcement interspersed within a matrix of agglutinating aluminum material.

The selected ribbon has a volume fraction of between about 10 and about 40 volume percent SiC particles having an average particle size of between about 1 and about 50 microns. The remainer is matrix material, such as aluminum, aluminum-silicon, or other aluminum alloys and various additives or residuals.

The ratio of SiC reinforcement to Al matrix material is determined by the application. Where closer CTE matching is required, higher volume fractions may be necessary. However, use of mass-produced Al—SiC is preferred for greater economic benefit.

In general, this method involves selecting a billet of relatively inexpensive, mass-produced Al—SiC composite material commonly used in the automotive parts industries and is commerically available in the range of 10 to 50 volume percent SiC, from Duralcan of Detroit, Michigan; LEC of Newark, Dela.; or DWA of Chatsworth, Pa.

The billet is of a size and shape which may be readily loaded into a vertical or horizontal extruder. Therefore, billet mass preferably ranges between about 1 and about 250 pounds, and preferably is cylindrical in shape having a length ranging between about 0.25 meter and about 2.0 meters, and a diameter ranging between about 2.0 centimeters and about 50 centimeters.

The billet is preferably hot-extruded at a temperature of between about 450 and 1150 degrees Fahrenheit at an applied force of between about 100 and 5000 tons. This results in an extrusion output rate of between about 10 and about 45 feet per minute to form a wrought strip which measures between about 0.25 and about 10 inches wide by about 0.025 and about 0.25 inch thick which is wound upon a spool. To reduce extrusion die wear, a lubricant such as a graphite in water from the Deltaforge series produced by Acheson Colloids Company of Port Huron, Mich. may be used.

The dimensions of the strip are selected to accommodate the later rolling steps in a two-high type rolling mill. Those skilled in the art will readily appreciate the differently dimensioned strips may be selected for different rolling machinery.

Preferably, the extruded strip is preheated in an induction-type heater to between about 700° F. and about 800° F. just prior to rolling. Alternately, or additionally, the mill rollers themselves may be heated. If the strip is not preheated, the rollers are preferably heated to between about 300 and about 600 degrees C for a roller speed of between about 1 and about 20 feet per minute.

The strip is then rolled one or more times to achieve the above-defined Al—SiC ribbon. For each rolling step, it has been found preferable to use speeds of between about 1 and 20 feet per minute, and a roller spacing which results in a single pass thickness reduction of between about 5 and 50 percent, and most preferably between about 10 and about 30 percent. A roller lubricant such as a vegetable-based oil may be used to prevent roller adherence to the strip/ribbon.

It is understood that after extrusion and between one or more of the rolling passes, various processing steps such as shearing, annealing, stripping, drying and/or cleaning may be required to remove imperfections caused by the rolling and any intermediate handling of the strip and in preparation of subsequent steps. The AlSiC ribbon is then annealed at about 900 degrees F for about 3 hours, then temperature reduced about 50 degrees pre hour to room temperature.

As shown in FIG. 4, the Al—SiC ribbon tends to have a cross-section in which the opposite lateral edges 6, 7 are rounded due to the extrusion processing and may help avoid cracking during subsequent rollings.

A pre-clad ribbon of an outer metal such as copper, pre-clad with a bond-enhancing material such as aluminum, is selected having a thickness of between about 0.010 and 0.025 inch and a width of between about 1.0 and 10.0 inches. The thickness of the aluminum layer is preferably between about 5 and 25 percent of the overall thickness of the preclad ribbon. The pre-clad ribbon may be formed through processes well-known in the art as described generally in The Processing and Evaluation of Clad Metals, J. A. Forster, S. Jha, and A. Amatruda, JOM June 1993, pages 35-38, incorporated herein by this reference.

In general, these steps include selecting an outer metal strip of copper having a thickness of between 0.025 and 0.075 inch, and most preferably, about 0.050 inch, a width of between about 1.0 and 10.0 inches, and a length of at least a few feet. Most preferably, the copper strip is dozens of feet in length and wound upon a spool.

Next, a bond-enhancing material strip of aluminum is selected, having a thickness of between about 0.010 and about 0.035 inch, and most preferably, about 0.020 inch, and a width of between about 1.0 and 10.0 inches. Those skilled in the art of cold roll cladding shall understand that the width of the bonding layer strip is slightly greater than the width of the copper strip due to its relative softness or thinness. If aluminum silicon is used, it should be between about 90 and 95 weight percent aluminum.

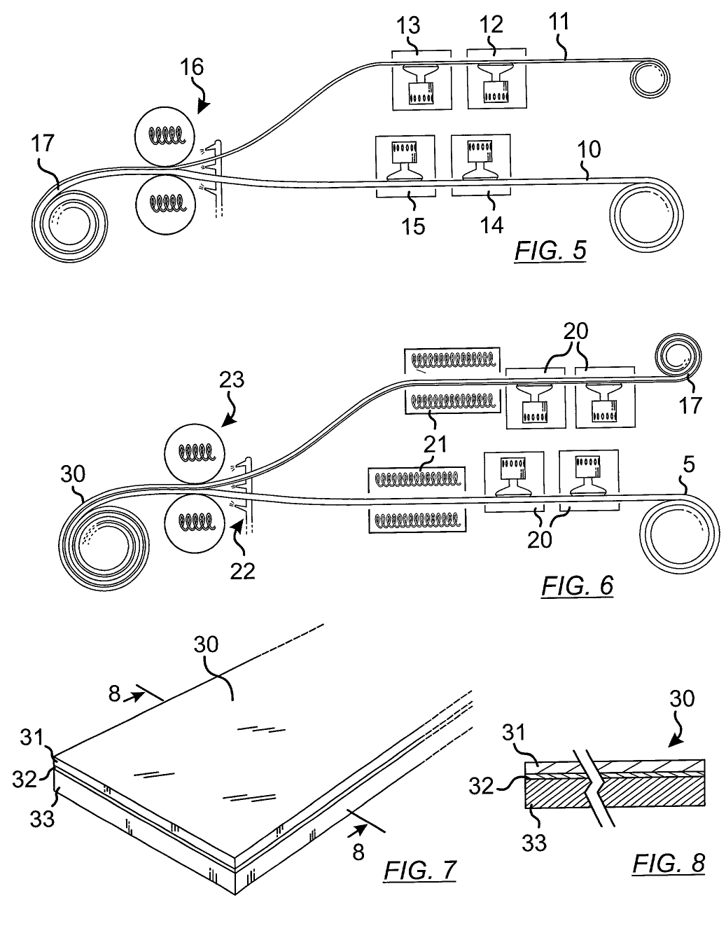

As shown in FIG. 5, the copper strip 10 and the aluminum strip 11 are then clad together through a sandwiched rolling step. Both strips are first simultaneously fed through a series of brushing stations to remove oxides and otherwise prepare the contact surfaces for cladding. The first station 12, 14 uses a two-head 6000 stainless steel greaseless brush. The second station 13, 15 uses a 5000 stainless steel greaseless brush. The strips then continue through a two-high type rolling mill 16 which cold rolls the strips together to form a pre-clad copper aluminum (“Cu—Al”) ribbon 17. The roller spacing is set to reduce the thickness of the resultant ribbon by no more than about 50%, and more preferably, no more than 30%, otherwise significant peeling was observed. Although not necessary, it is preferable to maintain a non-oxidizing atmosphere between brushing and rolling, thereby further enhancing the aluminum-to-copper bond.

The pre-clad Cu—Al ribbon may then be passed through the rolling mill a number of subsequent times to further reduce its thickness and then annealed in preparation for being clad to the Al—SiC ribbon. Final thickness prior to Al—SiC cladding is most preferably about 0.015 inch. Annealing is preferably about 900 degrees F in a 90% nitrogen, 10% hydrogen atmosphere.

As shown in FIGS. 6-8, the pre-clad Cu—Al ribbon 17 and the Al—SiC ribbon 5 are then clad together through a sandwiched bonding rolling step. Both ribbons are first simultaneously fed through a series of brushing stations 20 to remove oxides and otherwise prepare the contact surfaces for cladding. The first station uses a two-head 6000 stainless steel greaseless brush. The second station uses a 5000 stainless steel greaseless brush. The ribbons are then preheated in induction-type heaters 21 to minimize cracking and maintain flatness. The preferred temperature depends on the thickness reduction and whether a non-oxidizing atmosphere is used. Preferably, the temperature is between about 300° C. and about 500° C., and most preferable about 400° C. just prior to bond rolling. Alternately, or additionally, the mill rollers themselves may be heated. If the strip is not preheated, the rollers are preferably heated to between about 300 and about 600 degrees C assuming a roller speed of between about 1 and about 6 inches per minute.

There is a tradeoff in the heating of the Al—SiC ribbon. Although hotter AlSiC is easier to roll, hotter Al—SiC also forms bond-depleting oxides on its surface. Therefore, hotter heating of the Al—SiC is preferably done in a non-oxidizing atmosphere. Further, the at of rolling can increase the temperature of the ribbon to a degree where oxides quickly form. Therefore, jets 22 of a non-oxidizing gas may be directed upon the ribbon during rolling.

The ribbons are bond rolled together in a two-high type rolling mill 23 to form a copper-aluminum-Al—SiC (“Cu—Al—AlSiC”) ribbon 30 comprising layers of copper 31, aluminum 32 and Al—Sic 33. The roller spacing is set to reduce the thickness of the resultant ribbon by no more than about 30%, otherwise significant cracking was observed.

The Cu—Al—AlSiC ribbon is then rolled one or more times to achieve the ribbon at a final thickness. Of course, fewere rolings would be preferred to reduce manufacturing costs. However, the structure of the ribbon may be damaged if the single pass reduction in thickness is too drastic. Further, some between-pass treatment of the ribbon such as annealing may be necessary, especially if drastic per pass reduction is performed.

For each subsequent roling step, it has been found preferable to use speeds of between about 1 and 20 feet per minute, and a roller spacing which results in single pass thickness reduction of between about 5 and 50 percent, and most preferably, between about 10 and about 25 percent.

Depending on the milling machine used and, more importantly, the material forming the roller, their speed and pressure, a roller lubricant such as silicon oil is generally preferred.

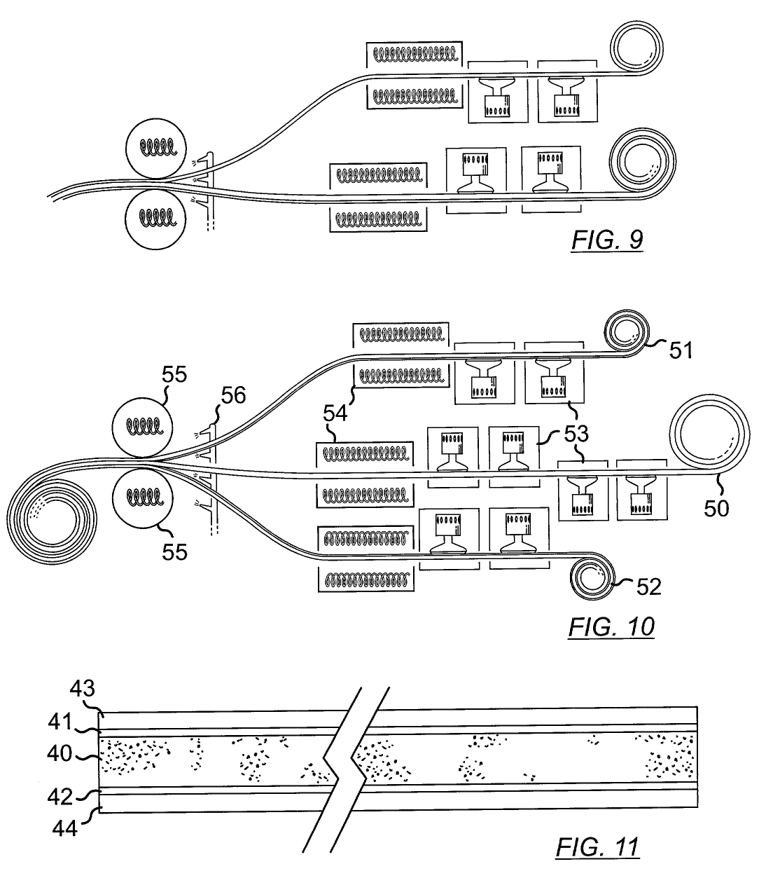

The Cu—Al—Al—SiC ribbon produced by the above-process may be further processed by cladding a pre-clad Cu—Al ribbon to the opposite side of the Al—SiC layer, thereby forming the clad laminate structure of FIG. 11 wherein a central Al—SiC core 40 is sandwiched by aluminum layers 41, 42 which in turn are sandwiched by copper layers 43, 44. As shown in FIG. 9, the cladding of the second pre-clad Cu—Al ribbon can occur through steps substantially the same used to clad the first pre-clad ribbon. Of course, roller spacings must be adjusted accordingly.

More specifically, as shown in FIG. 10, both sides of an Al—SiC ribbon 50 may be clad with a pair of Cu—Al ribbons 51, 52 in a single bond rolling step in one mill. As before, brushes 53 prepare the contact surfaces, induction heaters 54 and heated rollers 55 heat the ribbons prior to and during rolling, while jets 56 of the non-oxidizing atmospheres are directed.

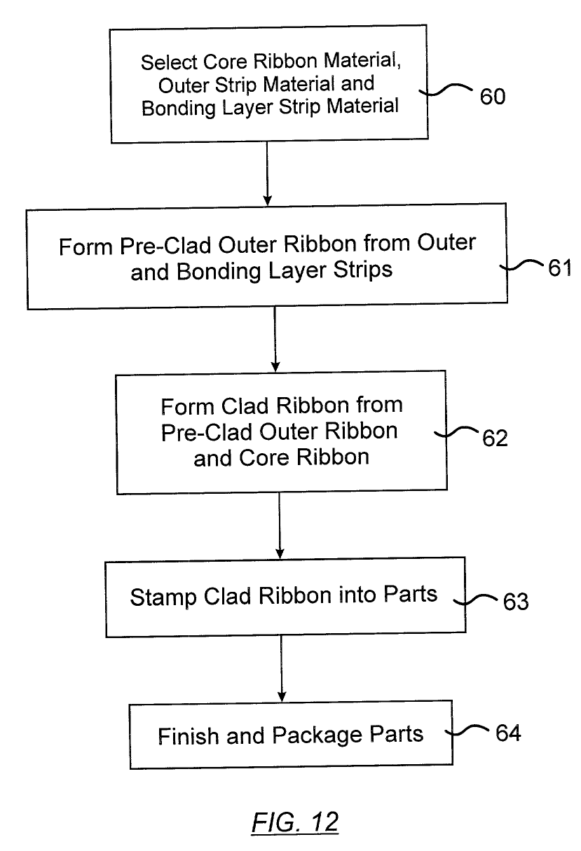

Therefore, referring to FIG. 12, the preferred process steps will include first selecting 60 core ribbon material which can be a metal matrix composite and selecting the outer strip material which can be a high thermal conductivity material such as copper and selecting a bonding layer material which enhances the bond between the outer strip material and the core ribbon material.

Next, a pre-clad outer ribbon is formed 61 from the outer and bonding layer strips. Then, the final clad ribbon is formed 62 by cladding together the pre-clad outer ribbon and the core ribbon. Further processing of the clad ribbon into the heat-dissipating component parts are then performed which can include stamping 63 the clad ribbon into parts and further finishing and packaging 64 of the separated parts.

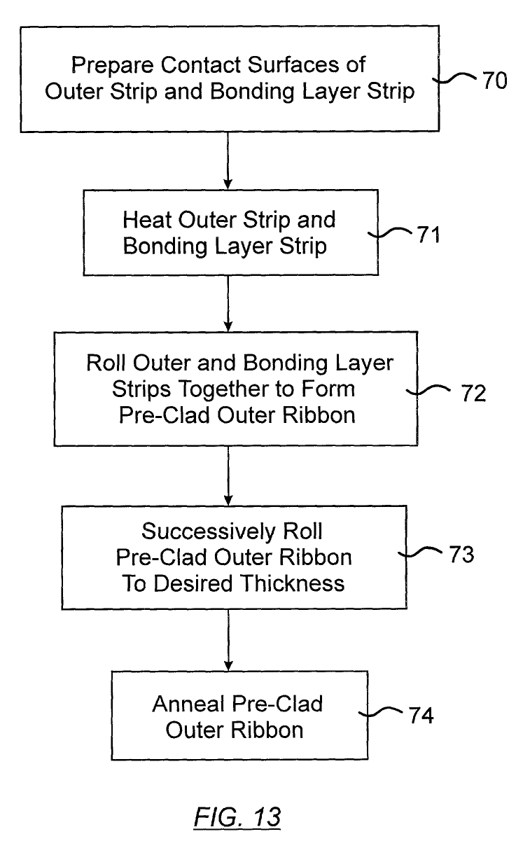

Referring now to FIG. 13, the preferred process steps for forming the pre-clad outer ribbon includes first preparing 70 the contact surfaces of the outer strip and the bonding layer strip. Then, heating 71 both the outer strip and the bonding layer strip. The heated strips are then rolled 72 together to form the pre-clad outer ribbon. Alternatively, successive rolling steps 73 may be taken to determine the desired thickness of the pre-clad outer ribbon. Further, the pre-clad outer ribbon may be annealed 74 to prepare it for cladding to the core ribbon.

The clad ribbon may then be stamped, coined, forged or otherwise machined to form each of the pallets. Such stamping individualizes each pallet from the clad ribbon stock. Heretofore, all processing has occurred on the ribbon stock which comprises the material for many pallets, thereby allowing more efficient low-cost manufacturing. It is understood that manufacturing costs per pallet will decrease as more pallets can be formed from a given ribbon stock. Therefore, the amount of clad ribbon material should be sufficient to preferably make a plurality of pallets, more preferably, at least 10 pallets, even more preferably, at least 100 pallets and most preferably, at least 1000 pallets.

In general, the term “stamping” has come to mean pressing a portion of stock material such as a ribbon to separate off or individualize a part for later processing. The term “coining” generally means pressing an existing part or plug so as to reshape it without removing a large portion of material. The term “forging” generally means stamping or coining while the material has been heated.

Due to the hardness and abrasiveness of Al—SiC, the stamping or coining die or tool is preferably made from hard material such as tool steel, for example, tool steel type A2 or D2, or more preferably a carbide material such as cobalt tungsten carbide, or those materials having a metal such as nickel or iron bonded in combination with a refractory hard metal carbide such as titanium carbide or tantalum carbide.

Various finalization steps may be performed depending on the application. This can include plating, soldering, anodizing, chromating, phosphating, zincating, resurfacing through machining, sputtering, spraying, vapor depositing and etching, and printing.

While the preferred embodiments of the invention have been described, modifications can be made and other embodiments may be devised without departing from the spirit of the invention and the scope of the appended claims.

What is claimed is:

1. A lightweight heat-dissipating material comprises:
a metal matrix composite material layer wherein particles of a ceramic are interspersed within a fused aggregate of a matrix material;
a second metal layer wherein said first and second layers are clad together.

2. The material of claim 1, wherein said second metal layer comprises:
a contacting layer portion of a first metal clad to a backing layer portion of a second metal.

3. The material of claim 1, wherein said material further comprises a third metal layer clad to said composite material layer on a side opposite from said second metal layer.

4. The material of claim 1, wherein said metal matrix composite material comprises aluminum silicon carbide.

5. The material of claim 4, wherein said aluminum silicon carbide comprises between 10 and about 40 volume percent silicon carbide particles.

6. The material of claim 2, wherein said contacting layer is selected from a group consisting of aluminum and aluminum silicon.

7. The material of claim 2, wherein said contacting layer comprises aluminum silicon being between about 90 and 95 weight percent aluminum.

8. The material of claim 2, wherein a thickness of said contacting layer portion is between about 5 and 25 percent of an overall thickness of said second metal layer.

9. The material of claim 2, wherein said backing layer portion comprises a metal selected from the group consisting of copper, steel, nickel-iron alloys, Kovar-type metal material, titanium and bronze.

10. A process for manufacturing a clad material comprises:
selecting a first sheet of metal matrix composite material;
selecting a second sheet of metal material;
heating said first sheet; and
pressure-rolling both sheets to form a bond between said first and second sheets.

11. The process of claim 10, wherein said selecting a first sheet comprises selecting an aluminum silicon carbide sheet; and
wherein said selecting a second sheet comprises selecting a copper aluminum laminate sheet.

12. The process of claim 11, wherein said heating comprises heating to between about 300 and about 500 degrees centigrade.

13. The process of claim 12 which further comprises heating said rollers to between about 300 and about 600 degrees centigrade.

14. The process of claim 10, wherein said rolling comprises rolling in an oxide inhibiting atmosphere.

15. The process of claim 14 which further comprises forming a jet of nitrogen gas onto said first and second sheets prior to said rolling step.

16. The process of claim 11 which further comprises treating a surface of said first sheet to remove oxides.
